(19) United States
(12) Patent Application Publication
(10) Pub. No.: US 2010/0145775 A1
(43) Pub. Date: Jun. 10, 2010

(54) System and method for computer program implemented internet environmental information exchange and marketplace

(76) Inventor: Maria Alejandra Torres, Coconut Grove, FL (US)

Correspondence Address: THE MILLER LAW OFFICES, PLC, 801 BRICKELL AVE, SUITE 900, MIAMI, FL, 33131, US

(21) Appl. No.: 12/634,659

(22) Filed: Dec. 9, 2009

Related U.S. Application Data
(60) Provisional application No. 61/121,534, filed on Dec. 10, 2008.

(51) Int. Cl. G06F 15/16; G06Q 20/00; G06Q 30/00; G06Q 50/00

(52) U.S. Cl. 705/12; 709/205

(57) ABSTRACT

The system and method described below relates to modeling and implementation of an internet based computer program that comprises a system for the marketing and central system of user exchange of environmental, social and spritual content and information, through a website, together with optional user registration, green content websites promotion system having user uploaded explanatory content, highlighting important green issues, a user voting system for all user's uploaded content of whatever type (other website links, viisual media, audio media, text, etc.), a user rating system, a user bidding system, a user carbon footprint analysis algorithm, an algoritm to generate an award for registered users, said algoritm taking input data from all users voting, ratings, type of uploaded content, quality of said content, focus of said content, variety of said content, user chat rooms that may simultaneously access any uploaded content, through said on-line internet website.

### CROSS REFERENCE TO RELATED APPLICATIONS

This non-provisional patent application claims priority from U.S. provisional patent application No. 61/121,534, filed on Dec. 10, 2008.

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

1. Field of the Invention

The system and method described below relates to modeling and implementation of an internet based computer program that comprises a system for the marketing and central system of website user exchange of environmental, social and spritual content (together hereinafter referred to as “green” content) and information, through a website, together with optional user registration, green content websites promotion system comprising user uploaded explanatory content, (including, but not limited to video and other visual media, audio, text, imagery) highlighting important green issues, a website user voting system for all user's uploaded content of whatever type (including, but not limited to other website links, video, audio, text, art, photographs), a user rating system that confidentially sends rating information to websites that have chosen to be linked to this systems website exchange, a rating system for registered users to rate one anothers content, a user carbon footprint analysis algorithm, an algoritm to generate a “green” award for users, said algoritm taking input data from all users voting, ratings, type of user uploaded content, quality of other linked websites, quality of user or other website linked content, uploaded content, focus of said content, variety of said content, registered user “green” chat rooms that may simultaneously access any of the users' uploaded “green” content, through said on-line internet website.

2. Prior Art

In the prior art, an individual specifically interested in environmental, social and/or spiritual issues was able only to use a search engine to find one or more specific websites which provided information and content on one or more of the said subject areas, and the users were limited to said internet on-line activities. Also, these websites while informative, did not allow for the unique ability to draw persons who are not environmentally, socially and spiritually conscious to become attracted to these issues, through the use of the present inventions unique interactive internet based method, comprising the ability to upload a plethora of environmental, social and spiritual content (including, but not limited to, video, audio, text, weblinks, art, imagery), wherein said content is reviewed, discussed in chat rooms, available to be evaluated by all users, voted on and otherwise rated, said content being also able to be exhanged for value, user's ideas marketed through said website and its exchange. The instant invention not only for provides for a complete interactive marketing place and exchange for environmentally, socially and spiritually conscious persons, but through it's unique algorithms' anaysis of the user content upoads, user voting system, user rating system, and other user inputed data, analyze users' carbon footprint and other user green scoring, the system will score registered user's green consciousness, and as appropriate award registered users. Objectives for this invention is to solve the problem the “green” industry has had in drawing new not otherwise environmentally, socially and spiritually conscious people to become more “green” conscious and responsible. This invention improves the “green” industry's business in such a way that as to expand the said industry industry. This will bring in new people to become environmentally, socially and spiritually (“green”) conscious. Accordingly, what is needed is a system and a method implemented by a computer program, through a stand-alone computer or a computer network coonected to the world wide web internet, which enables an individual to ability to access a system for exchanging and marketing “green” ideas through an interactive website, a user content upload system, a user data entry system, a user chat system, a user voting system, a user rating system, an “green” scoring and award system, This invention resolves these prior deficiencies.

### SUMMARY OF THE INVENTION

The system and method disclosed in the preferred embodiment can be implemented on any computer or computer terminal which is connected to a single computer or computer network connected to a global public network such as the world wide web, wherein said system and method which will enable an individual the ability to access a system for the marketing and central system of user exchange of environmental, social and spritual content (together hereinafter referred to as “green” content) and information, through a website, together with user registration, green content websites promotion system comprising user uploaded explanatory content, (including, but not limited to video and other visual media, audio, text, imagery) highlighting important green issues, a user voting system for all user's uploaded content of whatever type (including, but not limited to other website links, video, audio, text, art, photographs), a user rating system, a user bidding system, a user carbon footprint analysis algorithm, an algoritm to generate a “green” award for registered users, said algoritm taking input data from all users voting, ratings, type of user uploaded content, quality of said content, focus of said content, variety of said content, registered user “green” chat rooms that may simultaneously access any of the users' uploaded “green” content, through said on-line internet website.

In one embodiment, the system will allow an individual computer program user to optionally register on-line, then said user will be able to select from the options of uploading a plethora of environmental, social and spiritual content (including, but not limited to, video, audio, text, weblinks, art, imagery), wherein said content is reviewed, discussed in chat rooms, available to be evaluated by all users, voted on and otherwise rated, said content being also able to be exhanged for value, user's ideas marketed through said website and its exchange.

The invention provides for electronic banking transfers to and from a user designated bank account, and on-line registration and other payments with credit and debit cards, and transfers with a Paypal® and other similar banking systems, as may be required.

### DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

In the drawings:

FIG. 1 is a block diagram of the basic main initial sequential process that an individual would effect in practicing one embodiment of the invention.

### DETAILED DESCRIPTION OF THE EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

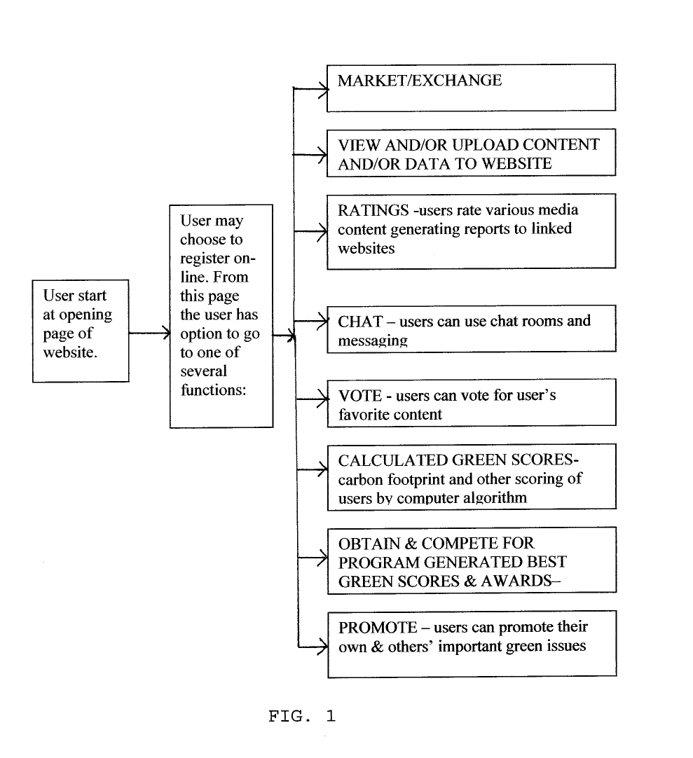

Reference will now be made in detail to an exemplary embodiment of the system, an example which is illustrated in the accompanying drawings (FIG. 1).

FIG. 1 is a block diagram of the sequential process that an individual would effect in practising one embodiment of the invention. It describes the logical sequence that an individual user or customer would encounter in the process of proceeding through the computer program appearing on a global public network website. A user or customer would enter a website, obtained by knowing the domain name or by obtaining said domain name through a search engine, and said user or customer would start at the opening page of website. From this page, the user would decide whether to select “register” or not, and using the computer cursur positioning device, such as a mouse, the user would click on said webpage choice, said user will then be able to select from the options of uploading and/or viewing a plethora of environmental, social and spiritual content (including, but not limited to, visual media, audio media, text, weblinks, art, imagery), wherein said content is reviewed, discussed in chat rooms, available to be evaluated by all registered users, voted on and otherwise rated, green content websites promotion system comprising user uploaded explanatory content, (including, but not limited to video and other visual media, audio, text, imagery) highlighting important green issues, user's being scored as how green they are base on their uploaded content and data, said content being also able to be exhanged for value, user's ideas marketed through said website and its exchange.

Said selections comprise a voting system, a user rating system, a scoring and award system, chat rooms, through said on-line internet website. The embodiment comprises an optional ability to have the system score a user's carbon footprint, and other “green” evalusting metrics. This embodiment of the invention provides for electronic on-line payments as may be required. Through the registration process, the user could electronically pay said user's membership fees, and also access said member's own secure bank account. This embodiment allows to user to utilize electronic bank transfers, Paypal®, credit cards and debit cards.

In so far as the description above and the accompanying drawing disclose any additional subject matter that is not within the scope of the claims below, the inventions are not dedicated to the public and the right to file one or more applications claiming priority from the subject application is reserved.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention.

What is claimed is:

1. A method implemented on a computer, the method comprising:
An ability for said computer to be electronically connected to a public global computer network, an individual user entering the opening display page of said computer implemented method connected to a global computer network, said opening page providing said user the option of deciding to register on-line, said individual user choosing to register, then said method displaying a subsequent page on a computer driven visual device, said displayed subsequent page providing said user the option of allowing said individual the ability to access a system for allowing said user to enter a registered user exchange for environmentally sensitive materials, the option for said user of uploading user's own content onto said website, the option for said user to rate all other website content and to have the results from said user ratings generate reports on said ratings, the option for said user to enter a user chat system that permits registered users to exchange messages with each other, the option for said user to enter an on-line voting system allowing said user to vote for said user's favorite environmental content, the option for said user to enter user's personal energy use data whereupon said computer implemented method calculates said user's carbon foot print, the option for said user to enter an on-line registered user contest that scores said user's efficient use of energy, the option for said user to promote said user's own uploaded environmentally related content.

2. A method according to claim 1, wherein said method is implemented by single stand alone computer.

3. A method according to claim 1, wherein said method is implemented on a private computer network.

4. A method according to claim 1, wherein said method is implemented on a computer electronically connected to a world wide web based internet public computer network.

5. A method according to claim 1, wherein said method, implemeneted through a computer, transmits payment, billing and shipping information, using commercially available on-line payment systems.
